(19) United States
(12) Patent Application Publication
(10) Pub. No.: US 2009/0154369 A1
(43) Pub. Date: Jun. 18, 2009

(54) Digital-channel-monitor unit

(76) Inventors: William J. Helvig, Emmaus, PA (US); Richard C. Downs, Elizabethtown, PA (US)

Correspondence Address: MONTGOMERY, MCCRACKEN, WALKER & RHOADS, LLP, 123 SOUTH BROAD STREET, AVENUE OF THE ARTS, PHILADELPHIA, PA, 19109, US

(21) Appl. No.: 12/157,288

(22) Filed: Jun. 9, 2008

Related U.S. Application Data
(60) Provisional application No. 61/008,088, filed on Dec. 18, 2007.

(51) Int. Cl. H04L 12/26

(52) U.S. Cl. 370/252

(57) ABSTRACT

A digital-channel-monitoring unit (DCMU) suitable for use in a coaxial-broadband network. The DCMU monitors quality, and integrity of digital and analog Radio Frequency (RF) channels from one or more remote locations in the network. These remote locations include one or more strategic locations between the headend, and a subscriber's premises, such as a business or home.

### CROSS-REFERENCE TO RELATED APPLICATIONS

The present patent application claims benefit of U.S. Provisional Application Ser. No. 61/008,088 filed on 18 Dec. 2007, which is incorporated herein by reference.

### TECHNICAL FIELD

The present invention relates generally to broadband networks, and more specifically, to Hybrid-Fiber-Coax (HFC) networks.

### BACKGROUND

With the migration of cable TV transmission technology from analog to digital, and with the addition of high speed data and digital telephony services, service providers—such as cable providers—are not able to readily monitor the integrity of each channel at multiple locations in their HFC network. Often, a service provider is unaware of a problem, until a subscriber calls to complain about a problem. Typical complaints include shoddy digital-telephone service, and/or poor television reception, i.e., the picture includes static, snow, shadows, etc.

If a complaint is received by the service provider, they will usually dispatch a technician to the subscriber's premises, when the problem cannot be diagnosed remotely. When the technician arrives at the subscriber's premises, the technician usually uses expensive handheld test equipment—such as meters and spectrum analyzers—to perform diagnostic tests to diagnose and fix the problem. Some tests may involve determining whether a problem is isolated to a single subscriber, or affects other subscribers.

Sending technicians on service calls is often time consuming, expensive, and complicated. Further, it may take more than one visit to correctly diagnose a problem. In some situations the service technician may misdiagnose a problem, or may arrive at a subscriber's premises to repair an intermittent problem that is absent during the service call. Additionally, subscribers are often inconvenienced by a service call, as they must await the technician's arrival usually over an unspecified half-day block of time.

Service providers are also finding it difficult to conduct voice-call quality tests to ensure acceptable Quality-of-Service (QoS) level for digital telephone services throughout their networks. Again, in many instances the service provider is ignorant of a voice-over-IP (VoIP) problem until the subscriber notifies them of the problem. When a technician is dispatched to the subscriber's premises to repair a VoIP problem, it usually involves the technician placing a test call. Many times the technician must rely on a second technician, located at the head end of the system, to observe whether the test call is received, and whether QoS is associated with the test call. Therefore, it may take a several technicians (remote and local) to pinpoint and/or diagnose a VoIP problem.

So, presently service providers are often unable to detect a problem in their network unless a subscriber complains. And the process for resolving a problem by dispatching of a technician to a subscriber's premises is expensive, cumbersome, and often inconvenient to the subscriber. Further, test equipment used by technicians to diagnose a problem is also expensive, and subject to theft, or accidental breakage.

### SUMMARY

To solve these and other problems, described herein is a digital-channel-monitoring unit (DCMU) suitable for use in a coaxial-broadband network. The DCMU monitors quality, and integrity of digital and analog Radio Frequency (RF) channels from one or more remote locations in the network. These remote locations include one or more strategic locations between the headend, and a subscriber's premises, such as a business or home.

In one embodiment, data communications with the DCMU is provided by a Data-Over-Cable-Service-Interface Specifications (DOCSIS) modem in the DCMU. This modem is referred to a “master modem.” A second DOCSIS modem in the DCMU, referred to as a “slave modem” is connected to the master modem via a Media Independent Interface (MII) bus. The slave modem is used to monitor the performance of downstream coaxial plant, using a receiver of the slave modem to demodulate, and analyze RF channels selected by the user. The parameters analyzed may include, but are not necessarily limited to, signal amplitude, Bit Error Rate (BER), Signal-to-Noise Ratio (SNR), and Modulation Error Ratio (MER). In addition to the system-voltage level, the temperature of the DCMU, and a tamper for the DCMU may be monitored.

It is possible for a user to set performance limits on the monitored parameters. When the user-defined limits are exceeded the DCMU may record the time, and date of the event, and also generate a Standard Network Management Protocol (SNMP) trap which is sent to the master modem. The master modem then forwards an alert message (trap) to a device at the headend, or some other alerting device.

The DCMU may also have the capability to generate an RF signal in the upstream band. The duration, frequency, amplitude, and modulation format (CW, QPSK, or QAM) of the upstream signal may be set by the user. The slave modem (and/or master modem) may also have the capability of operating as an independent DOCSIS modem for use in VoIP testing, and other DOCSIS-specific testing.

Thus, by installing one or more DCMUs at various locations between a headend, and a customer's premises, it is possible to continuously monitor both analog and digital signal quality across an entire Hybrid-Fiber-Coax (HFC) network. Placed at multiple locations along the HFC path, the DCMU enables a service provider to quickly and remotely monitor service availability, and isolate service impairments. The DCMU monitors RF level, and critical signal parameters, such as SNR, packet-error counters per monitored channel, BER, MER, etc., thereby providing a simple means to continuously assess the channel performance in both the analog and digital domains. The DCMU may also act as a remote IP probe in the HFC network performing tests in conjunction with other devices.

### BRIEF DESCRIPTION OF THE DRAWINGS

The detailed description is explained with reference to the accompanying figures. In the figures, the left-most digit(s) of a reference number identifies the figure in which the reference number first appears.

FIG. 1 illustrates an HFC network within which the present invention can be either fully or partially implemented.

FIG. 2 shows one exemplary implementation of the DCMU shown in FIG. 1.

FIG. 3 shows another exemplary implementation of a DCMU.

FIG. 4 is a block-diagram embodiment of a monitoring application residing in memory of a computing device (FIG. 1).

FIG. 5 illustrates an embodiment of a user interface displayed for a user of a computing device.

FIG. 6 illustrates another example of a user interface displayed for analysis a user of a computing device.

FIG. 7 illustrates another embodiment of a user interface displayed for a user of a computing device.

FIG. 8 illustrates an exemplary method for monitoring signal quality in a coaxial-broadband network.

### DETAILED DESCRIPTION

Reference herein to “one embodiment”, “an embodiment”, or similar formulations herein, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

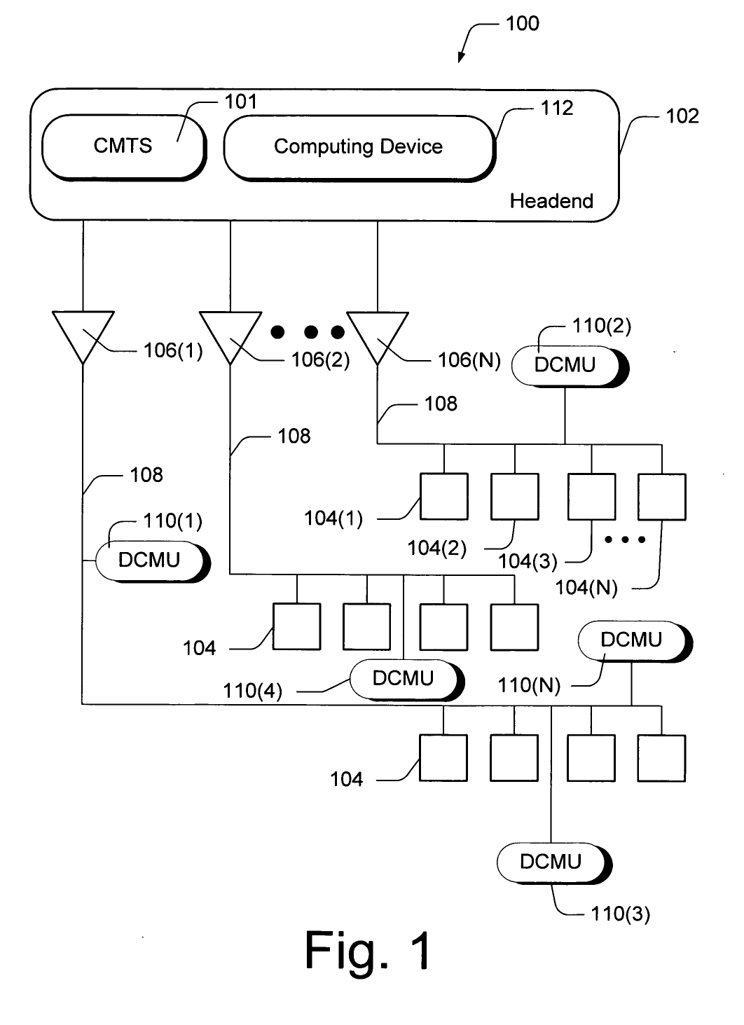

Described herein is a more efficient system and method for monitoring signal quality in a hybrid fiber coaxial (HFC) network, which helps to overcome many of the problems described in the Background section above. For instance, FIG. 1 illustrates a HFC network 100 within which the present invention can be either fully or partially implemented.

In one possible embodiment, network 100 includes a headend 102 which communicates with subscriber equipment, such as cable modems 104(1), 104(2), 104(3), . . . , 104(N) located in a home or business. Headend 102 may include cable modem termination system (CMTS) 101, as well as other devices.

Interposed between headend 102 and cable modems 104 are one or more distribution elements 106(1), 106(2), . . . , 106(N), sometime referred to in the industry as nodes. Each distribution element 106 converts signals from an optical fiber domain, to a cable coaxial domain, and vice versa. As appreciated by those skilled in the art, each distribution element 106 may include an assembly of devices used to communicate data to/from headend 102 and cable modems 104. Several distribution elements 106 are usually present in a network 100, each serving different geographical locations in network 100. Typically, each distribution element 106 supports, and communicates with approximately 25-to-5,000 cable modems 104.

Network 100 is bidirectional, meaning that data is carried in both directions on the same network from headend 102 to cable modems 104, and from cable modems 104 to headend 102. Data flow to the home/business is referred to as the “downstream” direction. Whereas, data flow to headend 102 is referred to as the “upstream” direction. Typically, downstream and upstream-data between each distribution element 106 is over the same coaxial cable 108.

As further appreciated by those skilled in the art, at various points along coaxial cable 108 are one or more amplifiers (not shown), used to amplify signals in either the downstream or upstream direction.

Further interposed between headend 102 and cable modems 104 are one or more digital-channel-monitoring unit (DCMU) 110(1), 110(2), . . . , 110(N), according to the present invention. In particular, each DCMU 110 is coupled, directly or indirectly, to coaxial cable 108. Each DCMU 110 is configured to monitor downstream and/or upstream communications at the particular location along coaxial cable 108 in which the DCMU is connected in network 100. That is, each DCMU 110 monitors channels (e.g., signals) in the downstream and/or upstream direction. It is appreciated by those skilled in art, after having the benefit of this disclosure, that one or more DCMUs may be located anywhere between headend 102 and cable modems 104.

In one embodiment, each DCMU 110 is programmable to scan upstream and/or downstream channels including analog and digital channels, and record desired information for observation by a service provider. For instance, each DCMU 110 may monitor and record the Radio Frequency (RF) level of each analog channel it scans. Further, in the digital realm, each DCMU 110 may monitor and record data information on a carrier channel to provide signal-to-noise ratio (SNR), bit-error rate (BER), modulation-error rate (MER), and a voltage, current and/or power measurement. Each DCMU 110 may also measure and record temperature levels, and the time each parameter (e.g., RF level, SNR, BER, MER, voltage, temperature) is recorded.

Once the information is recorded, each DCMU 110 may forward the recorded information to one or more remote computing device(s) 112, typically located at headend 102, where the data may be recorded, analyzed, and displayed. In one embodiment, computing device 112 is any intelligent computing device. As used herein, a computing device may include any general or special purpose computing device, such as, but not limited to, a server, a personal computer, workstation, a gateway, a combination of any of these example computing devices, or other suitable intelligent devices.

Also, as is appreciated by those skilled in the art, after having the benefit of this disclosure, computing device 112 does not necessarily have to reside at headend 102, and may reside at one or more other locations along network 100, or may be connected locally, or wirelessly to a DCMU 110. For example, computing device 112 may connect to DCMU 110 through an Ethernet or wireless connection. Further, computing device 112 may also be part of CMTS 101.

Based on parameters recorded by each DCMU 110, it is possible for a service provider to remotely monitor, and detect problems before they occur. Additionally, a DCMU 110 allows a service provider to remotely monitor a particular channel at various points along cable 108, and to trace down where a particular problem is observed in network 100. By observing where along cable—whether downstream or upstream—a problem occurs, it is possible to pinpoint (i.e., isolate and identify) the problem through a process of elimination, if more than one DCMU is interposed between headend 102 and cable modems 104.

In one embodiment, a DCMU 110 may also transmit signals upstream. For example, a DCMU may also have the capability to generate an RF signal in the upstream band. A duration, frequency, amplitude, and modulation format (CW, QPSK, QAM or other suitable signals) are all configurable. A DCMU 110 may also act as a telephony device, and initiate a digital-service call so that other devices (such as computing device 112) may measure, and test various VoIP, and QoS parameters. It is also appreciated by those skilled in the art, after having the benefit of this disclosure, that other signals may be generated by a DCMU such as for DOCSIS-specific-testing signals, un-modulated signals, and so forth.

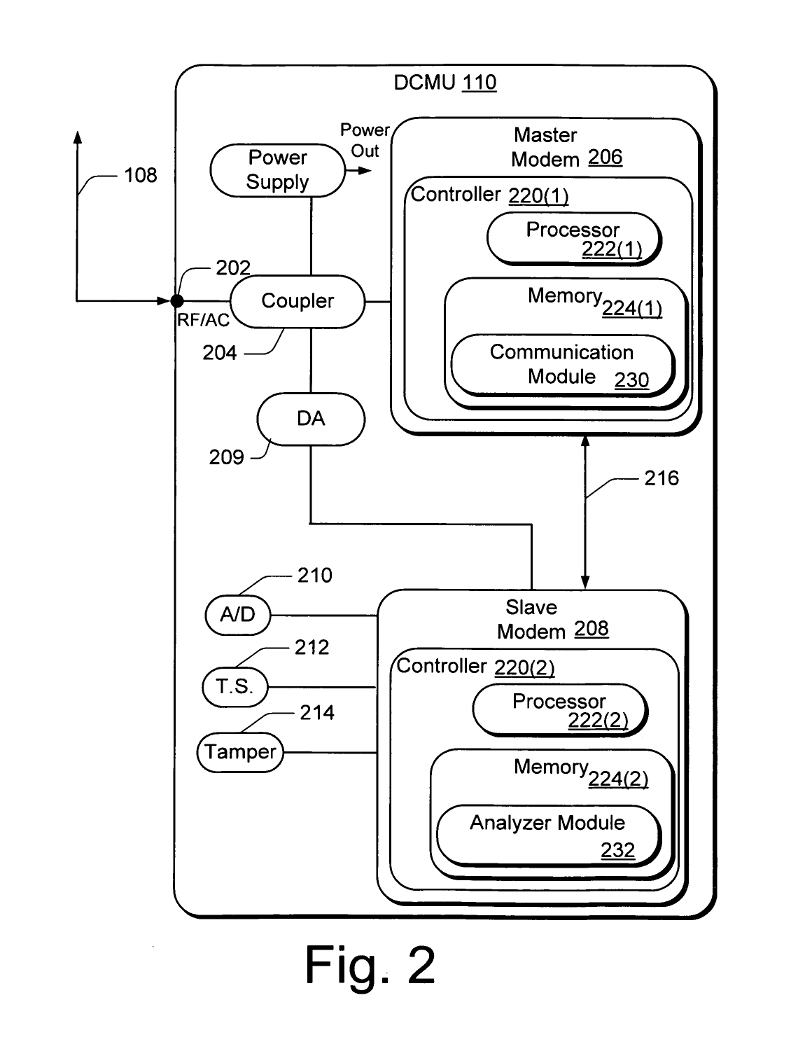

FIG. 2 shows one exemplary implementation of the DCMU shown in FIG. 1. As depicted in FIG. 2, DCMU 110 may include an RF/AC connection port 202, a coupler 204, a master modem 206, a slave modem 208, a digital attenuator 209, an analog-to-digital converter 210, a temperature sensor 212, and a tamper sensor 214.

RF/AC connection port 202 connects DCMU 110 to cable line 108. Port 202 includes any device or combination of devices capable of providing a link to both downstream and upstream communication domains of line 108. Port 202 also draws power from line 108, which provides power to DCMU.

For example, in one embodiment port 202 includes a power-passing-directional coupler 204. Connected to directional coupler 204 is a power supply 205, which may draw power from line 108 for supplying power to devices associated with DCMU 110.

Coupler 204 couples both downstream and upstream communications to/from master modem 206 and slave modem 208. A digital attenuator that is controlled by slave modem 208, is used to control the RF level at the slave port.

In one embodiment, master modem 206 is an off-the-shelf DOCSIS cable modem. Master modem 206 behaves as a DOCSIS modem in network 100. That is, master modem 206 operates in a registered mode (i.e., it registers as a cable modem) in network 100, and communicates with one or more devices in headend 102 using DOCSIS communication standards. For example, master modem 206 may receive downstream commands from computing device 112 (FIG. 1), and may forward recorded data upstream to computing device 112. Thus, in one embodiment master modem 206 communicates as a registered modem with headend 102.

In one embodiment, master modem 206 includes an embedded controller 220(1) including at least one processor 222(1), and memory 224(1). Memory 224(1) may include volatile memory (e.g., RAM) and/or non-volatile memory (e.g., ROM). In some implementations, volatile memory is used as part of modem's 206 cache, permitting application code and/or data to be accessed quickly and executed by processor 222(1). Memory 224(1) may also include non-volatile memory in the form of flash memory. It is also possible for other memory mediums (not shown) having various physical properties to be included as part of master modem 206 and/or DCMU 110.

Additionally, master modem 206 may include a communication module 230 configured to receive instructions from computing device 112, and forward commands to slave modem 208, based on instructions received from computing device 112. Additionally, communication module 230 may poll and/or automatically receive data from slave modem 208, and forward this data upstream to computing device 112 and/or other devices located upstream. Communication module 230 may be implemented as hardware, software and/or firmware. Communication module 230 is typically connected in some fashion to controller 220(1) (processor 222(1) and memory 224(1)).

Execution of code (e.g., communication module 230) by controller 220(1) causes master modem 206 to act as control unit for slave modem 208. That is, master modem 206 may communicate with, or send commands to slave modem 208. Execution of code (communication module 230) by controller 220(1) also causes master modem 206 to communicate with computing device 112 or other devices in headend 102. For example, master modem 206 may communicate with headed 102 using an SNMP protocol. So, master modem 206 serves as a communication interface between computing device 112 (or other devices in headend 102), and slave modem 208. Headend 102 may have no a priori knowledge of slave modem 208.

Master modem 206 is connected to slave modem 208 via an interface 216. In one embodiment interface 216 is a Media Independent Interface (MII) 216. As appreciated by those skilled in the art, after having the benefit of this disclosure, master modem 206, however, may be connected, directly or indirectly, to slave modem 208 via other suitable interfaces.

In one embodiment, slave modem 208 is an off-the-shelf DOCSIS cable modem, which operates in an unregistered mode in network 100 (i.e., it does not register with the headend 102). That is, slave modem 208 performs tasks, such as measuring or obtaining operational characteristics about a channel without having to register as a DOCSIS modem with headend 102. So, slave modem 208 is relieved of having to communicate as a registered modem (according to the DOCSIS standard) in network 100.

In one embodiment, slave modem 208 includes a receiver (not shown) suitable for demodulating and analyzing RF channels. Slave modem 208 includes a controller 220(2) including at least one processor 222(2), and memory 224(2). Memory 224(2) may include volatile memory and/or non-volatile memory (e.g., ROM). In some implementations, volatile memory 226(2) is used as part of modem's 208 cache, permitting application code and/or data to be accessed quickly and executed by processor 222(2). Memory 224(2) may also include non-volatile memory in the form of flash memory (not shown). It is also possible for other memory mediums (not shown) having various physical properties to be included as part of slave modem 208 and/or DCMU 110.

Slave modem 208 may also include an analyzer module 232 configured to receive, and record operational characteristics about a channel, in memory 224(2), and forward the recorded characteristics about a channel, or other events, to master modem 206 or other device(s). As used herein, operational characteristics about a channel include, but are not necessarily limited to, signal amplitude, BER, MER, and voltage level.

Analyzer module 232 may be implemented as hardware, software and/or firmware. Analyzer module 232 contains code that when executed by processor 222(2) of controller 220(2) causes slave modem 208 to measure (or receive measurements) and record operational parameters about a channel in memory 224(2). Analyzer module 232 also contains code that when executed by processor 222(2) causes slave modem 208 to record time and/or temperature readings, which are contemporaneous with the readings (i.e., measurements) recorded by slave modem 208. Analyzer module 232 may also utilize the receiver (not shown) to perform measurements. Analyzer module 232 is typically connected in some fashion to controller 220(2) (processor 222(2) and memory 224(2)).

Analyzer module 232 may also include code to perform upstream testing. For example, to generate upstream signals, such as voice-over-internet-protocol signals, and/or DOCSIS signals for testing purposes. Other suitable RF signals may be generated by slave modem 208. Additionally, a duration, frequency, amplitude, and modulation format (CW, QPSK, or QAM) of the upstream signal generated by slave modem 208 may be user configurable. Instructions/commands on the format of the signals, and other parameters may be configured by a user of computing device 112, which are transmitted by computing device 112 to slave modem 208, via master modem 204.

Slave modem 208 may also include, or have connected thereto, analog-to-digital (A/D) converter 210, temperature sensor 212, and a tamper sensor 214. A/D converter 210 converts analog characteristics into digital values.

Temperature sensor 212 detects temperature external to DCMU 110. This permits, slave modem 208 to record environmental temperatures at a location where the DCMU is located, and correlate these temperature readings with a time of day when the operational parameters, such as BER or MER, etc., were measured/recorded.

Tamper sensor 214 sends a signal to slave modem 208, if DCMU 110 is opened or removed, and reconnected to line 108. As appreciated by those skilled in the art, memory 224 may reside internally, and/or externally to both modems 206/208, and may be shared by both modems.

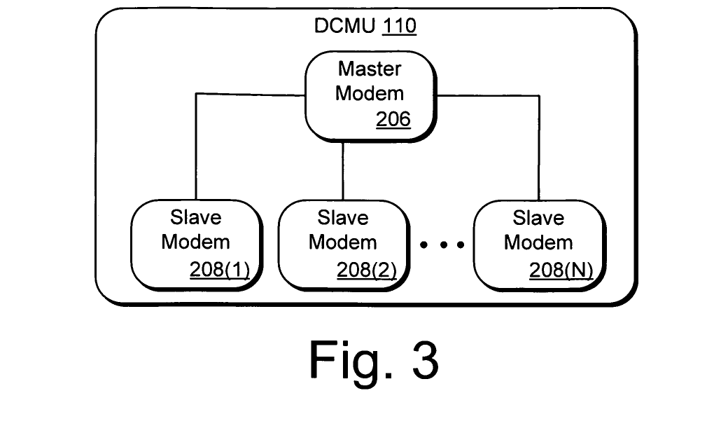

FIG. 3 shows another exemplary implementation of a DCMU shown in FIG. 1. According to this embodiment, DCMU 110 may include two or more slave modems 208(1), 208(2), . . . , 208(N). As appreciated by those skilled in the art, after having the benefit of this disclosure, using more than one slave modem 208, permits a DCMU to scan/test/monitor multiple channels in parallel. For example, slave modem 208(1) may monitor channels 1-10, slave modem 208(2) may monitor channels 11 50, . . . and slave modem 208(N) may monitor channels 500-1000, etc.

It should also be appreciated by those skilled in the art, that other devices may be used in place of the master and slave modems shown in FIGS. 2 and 3. For example, any suitable device or combination of devices capable of modulating or demodulating signals may be used as an alternative to master modem 206 and/or slave modem 208.

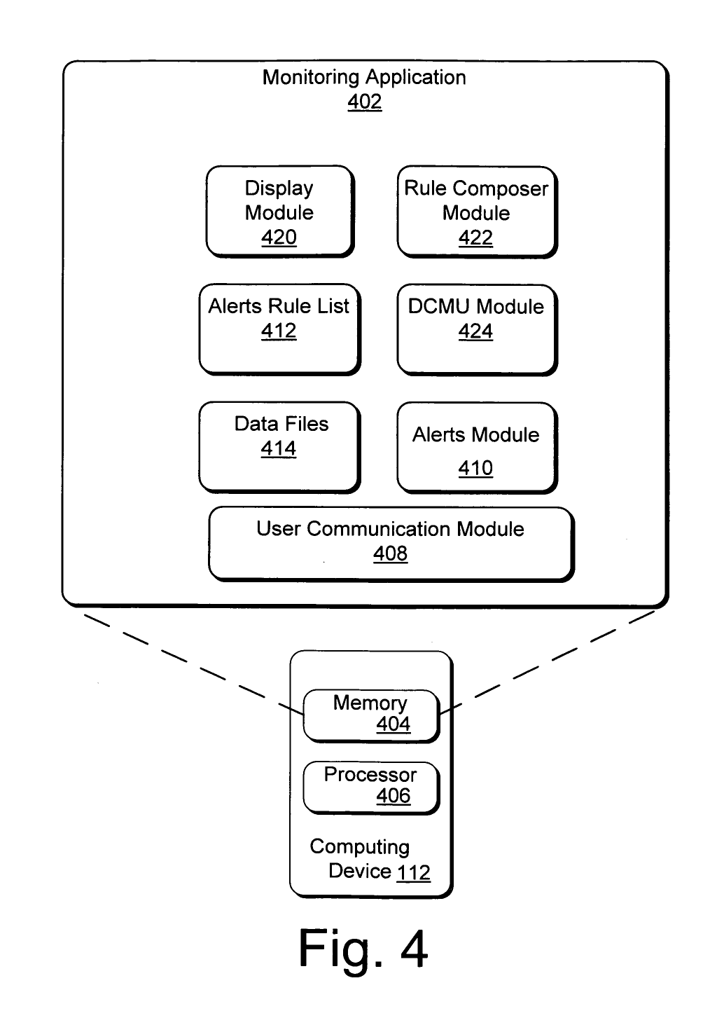

FIG. 4 is a block-diagram embodiment of a monitoring application 402 residing in memory 404 of computing device 112. In this example, monitoring application 402 comprises program modules and program data. Program modules typically include routines, programs, objects, components, and so on, for performing particular tasks or implementing particular abstract data types. A processor 406 is configured to fetch and execute computer program instructions from the program modules in memory 404, and is further configured to fetch data from program data 414 while executing monitoring application 402.

In one implementation, monitoring application 402 comprises, a user-communication module 408, an alerts module 410, and an alerts rule list 412

User-communication modulation 408 is a module that allows a user to interact with a user interface (to be described below). Using the user interface, the user can control and monitor the channel activity on DCMU 110. For example, user-communication module includes a display module 420 and a rule composer module 222.

Display module 420 enables a user to review and monitor tests and measurements recorded by DCMU. For example, display module 420 transmits a user interface for display on computing device 112.

Rule composer module 422 enables a user to configure and deploy rules for alerts. For example, a user may desire to set operational thresholds that if a certain operational characteristic is below or above, it is indicative of performance-alerting event. Depending on the severity of the condition, an alert message can be sent to the user via email or by other means. Additionally, an alarm may be sounded or other indications may be noted on the user interface. Examples of performance-alerting events include, but are not necessarily limited to: a monitored signal level of a channel exceeding or falling below a threshold, an error rate exceeding a threshold, a power failure, a voltage or current exceeding or falling bellowing a threshold, and so forth.

DCMU module 424 facilitates communication between DCMU and computing device 112.

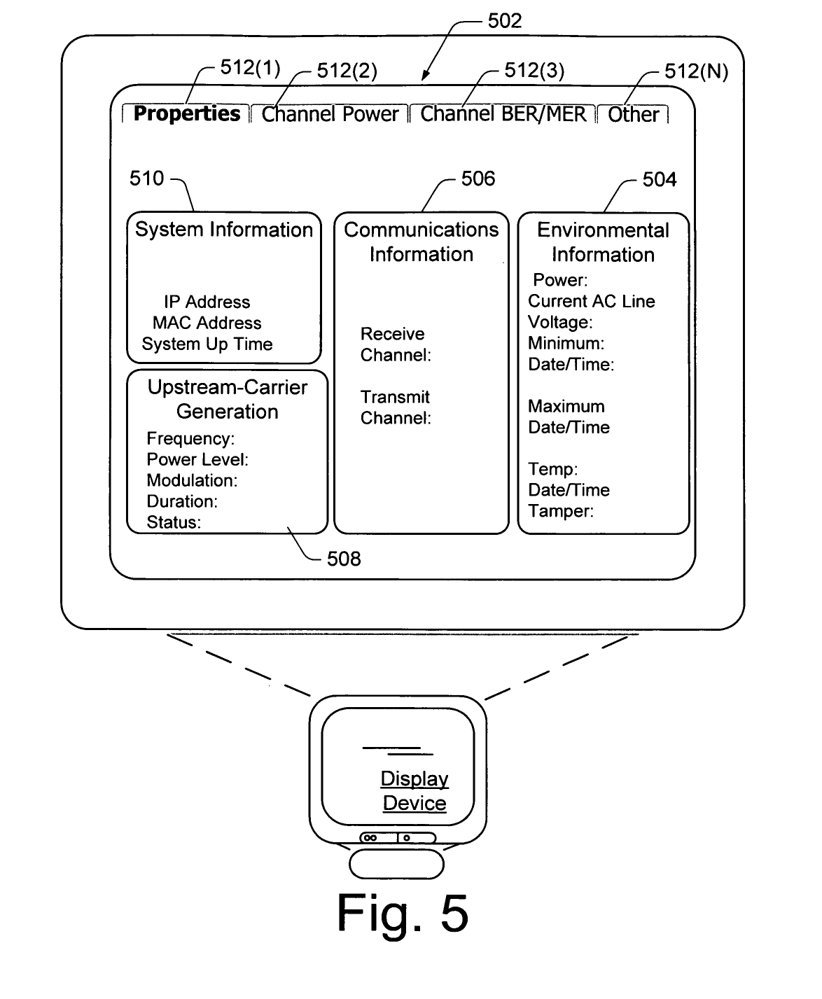

FIG. 5 illustrates an embodiment of a user interface 502 displayed for a user of computing device 112. Referring to FIG. 5, user interface 502 enables a user to click on various icons and view monitored channel activity based on different parameters, and operational characteristics of channels. For example, in one implementation, user interface 502 includes an environmental-information window 504, communication-information window 506, an upstream-carrier generation window 508, and system-information window 510. User interface 502 may also include tabs 512(1), 512(2) . . . , 512(N), which permit other information to be displayed.

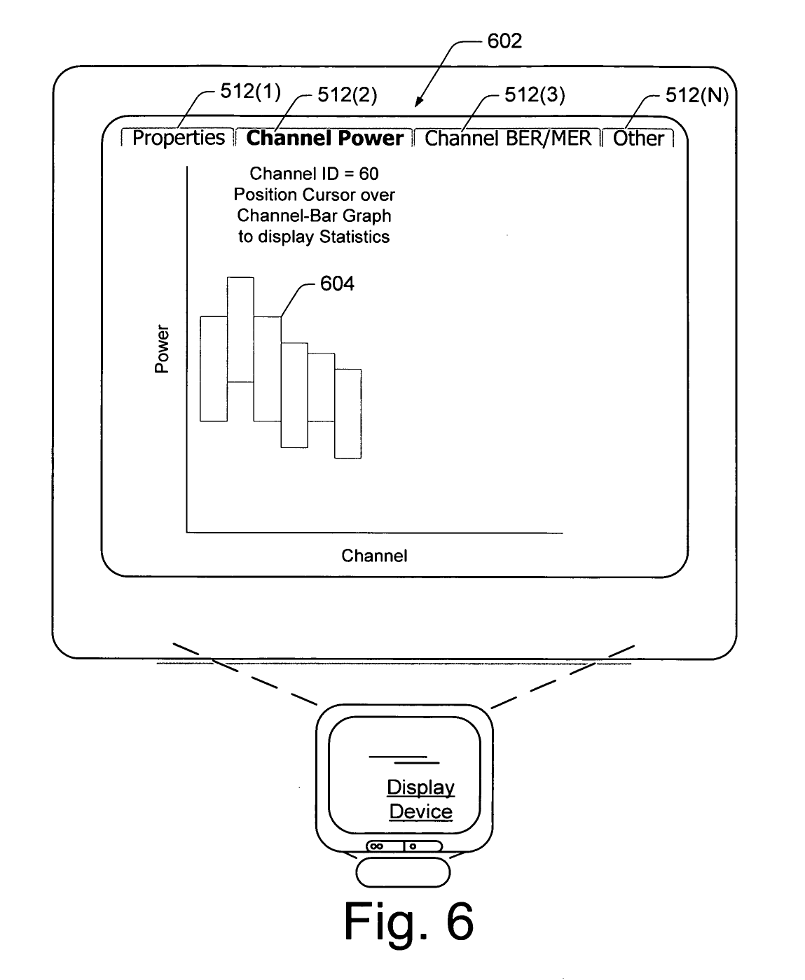

For example, if a user clicks on properties tab 512(1) user interface 502 is displayed. If a user clicks on a channel-power tab 512(2) a new user interface (or page) 602 (FIG. 6) is displayed. FIG. 6 illustrates another embodiment of a user interface 602 displayed for analysis by a user of computing device 112. As depicted in FIG. 6, user interface 602 displays bar graphs of all monitored channels showing the minimum and maximum current values. If alarm thresholds are set through rule composer module 422 (FIG. 4) bar graphs 604 may be colorized (such as in red) to show when characteristic exceeds the threshold. As appreciated by those skilled in the art, after having the benefit of this disclosure, that other indicia or mechanisms may be deployed to represent a characteristic exceeds or falls below a threshold.

If thresholds are not set by a user, default settings may simply record the events or set predetermined thresholds automatically. Clicking-on a particular bar graph associated with a channel may cause user interface 602 to be refreshed with real-time activity taking place on the channel as recorded by DCMU 110.

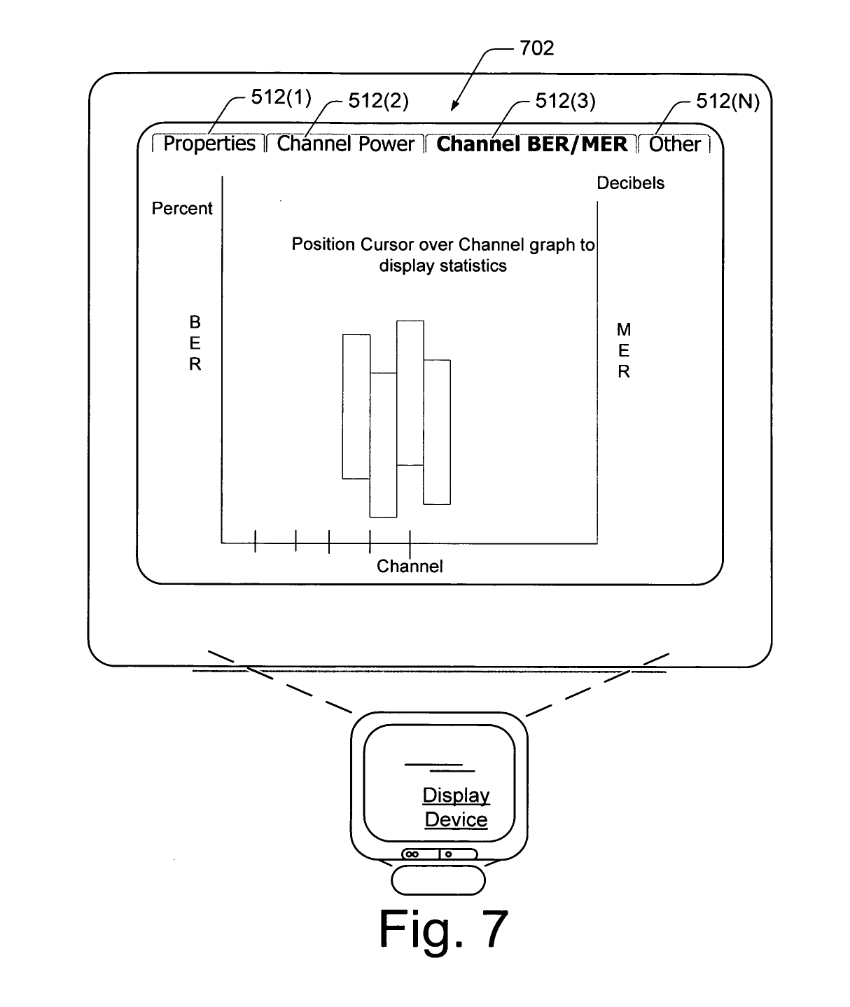

If a user clicks on a channel-power tab 512(3) (FIGS. 5, 6, or 7), another user interface (or page) 702 (FIG. 7) is displayed. FIG. 7 illustrates another embodiment of a user interface 702 displayed for a user of computing device 112. As depicted in FIG. 7, user interface 702 displays bar graphs of all monitored showing BER and MER tests of particular channels.

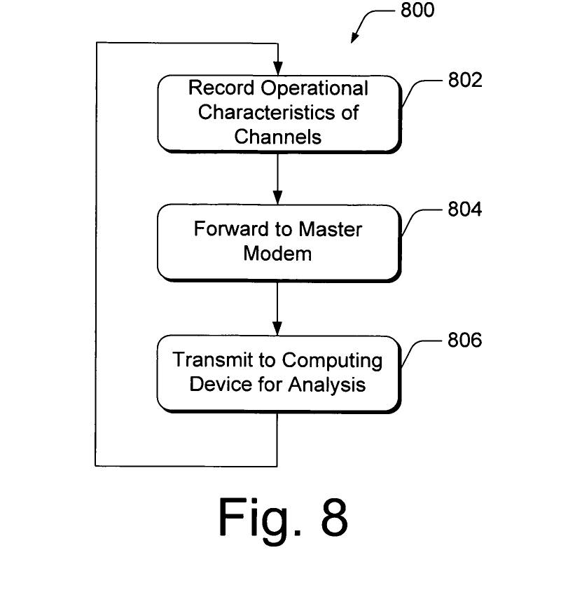

FIG. 8 illustrates an exemplary method 800 for monitoring signal quality in a coaxial-broadband network. Method 800 includes blocks 802, 804, and 806 (each of the blocks represents one or more operational acts). The order in which the method is described is not to be construed as a limitation, and any number of the described method blocks can be combined in any order to implement the method. Furthermore, the method can be implemented in any suitable hardware, software, firmware, or combination thereof. Additionally, although each module in FIG. 3 is shown as a single block, it is understood that when actually implemented in the form of computer-executable instructions, logic, firmware, and/or hardware, that the functionality described with reference to it may not exist as separate identifiable block.

Referring to FIG. 8, in block 802 a plurality of operational characteristics of a downstream channel are recorded. The particular operational characteristics are recorded in memory 224 (FIG. 2) of DCMU 110 (FIG. 1). The recording typically includes data indicating contemporaneous time, and temperature measurements corresponding to when the measurements of the operational characteristics were made.

In block 804, the recorded-operational characteristics are forwarded to a communication module. For example, the recorded-operation characteristics are transmitted to memory 224(1) (FIG. 2) of master modem 206 (FIG. 2) from memory 224(2) of slave modem (208) (FIG. 2). The recorded-operation characteristics may be sent to master modem 206 upon receiving a command from master modem, which is referred to as polling. Alternatively, a trap may be set to report an error or condition that exceeds or falls below a predetermined threshold, in which case slave modem 208 will push the data to master modem 206. The trap may also be set if any succession of operational characteristics occur with a specified period. For example, if an error rate occurs three times in one hour, then a trap is set.

In block 806, the recorded-operational characteristics are forwarded from memory 224(1) (FIG. 2) of master modem 208 (FIG. 2) to headend 102 (FIG. 1), such as computing device 112 (FIG. 1).

The embodiments described herein are to be considered in all respects only as exemplary and not restrictive. The scope of the invention is, therefore, indicated by the subjoined claims rather by the foregoing description. All changes which come within the meaning and range of equivalency of the claims are to be embraced within their scope.

What is claimed is:

1. A system for monitoring signal quality in a coaxial-broadband network, comprising:
a slave modem, operable in an unregistered mode in the network, in which the slave modem records a plurality of operational characteristics of downstream channels in the network without having to register as a cable modem in the network; and
a master modem, operable in a registered mode in the network, in which the master modem registers with a head-end system thereby providing a communication interface between the slave modem and the head-end system.

2. The system as recited in claim 1, wherein the slave modem and the master modem both are connected to a hybrid fiber-coax (HFC) line, and are both configured to draw their power from the HFC line.

3. The system as recited in claim 1, wherein the recording of the plurality of operational characteristics of downstream channels includes recording data indicative of at least one of a: signal amplitude, signal-to-noise ratio, bit-error rate, packet-error rate. and modulation-error rate associated with the downstream channel.

4. The system as recited in claim 1, wherein the slave modem is further configured to record an operational characteristic of an upstream channel.

5. The system as recited in claim 1, wherein the recording of the plurality of operational characteristics of the downstream channel includes recording data indicative of a performance-alerting event caused by the occurrence of at least one of: a detection of an operational characteristic below or above a specified threshold, and any succession of operational characteristics occurring within a specified period.

6. The system as recited in claim 1, wherein the recording of the plurality of operational characteristics includes recording data indicative of at least a temperature observed at a location within a vicinity of the unregistered modem.

7. The system as recited in claim 1, wherein the slave modem is further configured to generate upstream voice-over-internet-protocol signals, and/or DOCSIS signals for testing purposes.

8. The system as recited in claim 1, wherein the unregistered modem is further configured to scan a plurality of downstream channels, and record operational characteristics of each of the plurality of downstream channels.

9. The system as recited in claim 1, wherein the recording of the plurality of operational characteristics of downstream channels includes recording data indicative of at least one of: a voltage or current associated with a downstream channel, and voltage or current associated with an upstream channel.

10. The system as recited in claim 9, wherein the master modem is further configured to communicate with a head-end system using an SNMP protocol.

11. A method for monitoring signal quality in a coaxial-broadband network, comprising: using an unregistered modem in the network to record a plurality of operational characteristics of a downstream channel in the network; transferring the plurality of operational characteristics to a registered modem in the network; and transferring the plurality of operational characteristics from the registered modem in the network to a head-end system.

12. The method as recited in claim 11, further comprising using the registered modem as an interface for communicating between the unregistered modem, and an upstream device in the network.

13. The method as recited in claim 11, wherein the recording of the plurality of operational characteristics of a downstream channel includes recording data indicative of at least one of a: signal amplitude, signal-to-noise ratio, bit-error rate, packet-error rate, and modulation-error rate.

14. The method as recited in claim 11, wherein the recording of the plurality of operational characteristics of the downstream channel includes recording data indicative of a performance-alerting event caused by the occurrence of at least one of: (i) a detection of an operational characteristic below or above a specified threshold, and (ii) any succession of operational characteristics occurring within a specified period.

15. The method as recited in claim 11, wherein the recording the plurality of operational characteristics includes recording data indicative of at least one environmental characteristic, including at least one of: a temperature observed at a location within a vicinity of the unregistered modem or the registered modem, voltage or current associated with a downstream channel, and voltage or current associated with an upstream channel.

16. The method as recited in claim 11, further comprising using the unregistered modem to generate at least one of: a voice-over-internet-protocol signal and an upstream DOCSIS signal.

17. A method for displaying a graphical-user interface, comprising:
receiving a plurality of recorded-operational characteristics about a monitored-downstream channel in a coaxial-broadband network;
generating a first web-based page in response to user activity performed on a client device, the first web-based page containing details about the monitored-downstream channel including minimum and maximum power levels recorded over time; and
generating a second web-based page in response to user activity performed on a client device, the second web-based page containing details about the monitored-downstream channel including at least one of: a bit error rate and a modulation error rate.

18. The method as recited in claim 17, wherein the minimum and maximum power levels appear on the web-based page as a bar graph.

19. The method as recited in claim 17, wherein the bit error rate or the modulation error rate, appear on the web-based page as a bar graph.

20. A computer-readable medium comprising computer executable instructions for carrying out the method of claim 17.
